(19) United States
(12) Patent Application Publication
(10) Pub. No.: US 2026/0341992 A1
(43) Pub. Date: Oct. 29, 2026

(54) CONNECTOR AND HOUSING UNIT

(71) Applicant: YAZAKI CORPORATION, Tokyo (JP)

(72) Inventors: Mitsuhisa Sano, Susono-shi (JP); Kenichi Katsumata, Susono-shi (JP); Masato Ando, Makinohara-shi (JP); Naomi Kisu, Susono-shi (JP)

(21) Appl. No.: 19/646,127

(22) Filed: Apr. 13, 2026

(30) Foreign Application Priority Data
Apr. 28, 2025 (JP) 2025-074789

(51) Int. Cl. H01R 12/77

(52) U.S. Cl. CPC H01R 12/778

(57) ABSTRACT

A connector includes: a housing; a terminal; and a flat electric wire. The flat electric wire includes a conductor and an insulating layer sandwiching the conductor. The terminal includes a wall-shaped portion defining a space in which the conductor of the flat electric wire is to be disposed and facing an inner surface of an accommodating portion of the housing, a contact portion provided on an inner surface of the wall-shaped portion, and an engaging portion engaging with the insulating layer. One of the accommodating portion and the wall-shaped portion includes a protrusion protruding toward the other. In the connector, the protrusion is configured to come into contact with the other to cause the wall-shaped portion to be displaced so as to approach the flat electric wire, whereby the contact portion comes into pressure contact with the conductor, and the engaging portion engages with the insulating layer.

### CROSS-REFERENCE TO RELATED APPLICATIONS

This application is based on and claims priority under 35 USC 119 from Japanese Patent Application No. 2025-074789 filed on Apr. 28, 2025, the entire content of which is incorporated herein by reference.

### TECHNICAL FIELD

The present disclosure relates to a connector including a housing, a terminal configured to be accommodated in the housing, and a flat electric wire configured to be electrically connected to the terminal, and a housing unit used for the connector.

### BACKGROUND ART

In the related art, a circuit body (so-called wire harness) for connecting a power supply mounted on a vehicle or the like, an electric junction box, various electrical components, and the like has been known as disclosed in, for example, JP2005-078962A.

The circuit body of this type described above generally includes a plurality of electric wires, terminals attached to respective end portions of the plurality of electric wires, and a housing that accommodates the terminals. Since the circuit body of this type generally has a structure in which a plurality of electric wires are bundled together and integrated by wrapping a tape or the like around them, the diameter tends to increase as the number of circuits increases, and it is difficult to reduce the thickness. With respect to this, it is conceivable to implement a circuit body using a flat electric wire (for example, a flat flexible cable) that can be made thinner than an electric wire bundle. Even in the case of using the flat electric wire, it is desired to improve the reliability of the electrical connection between the flat electric wire and the terminal as in the case of using the related electric wire bundle.

An object of the present disclosure is to provide a connector and a housing unit excellent in reliability of electrical connection between a flat electric wire and a terminal.

In order to achieve the object described above, a connector and a housing unit according to the present disclosure are characterized as follows.

### SUMMARY OF INVENTION

A connector includes: a housing; a terminal configured to be accommodated in the housing; and a flat electric wire configured to be electrically connected to the terminal. The flat electric wire includes a conductor and an insulating layer sandwiching the conductor. The terminal includes a wall-shaped portion defining a space in which the conductor of the flat electric wire is to be disposed and facing an inner surface of an accommodating portion of the housing, a contact portion provided on an inner surface of the wall-shaped portion and configured to come into pressure contact with the conductor, and an engaging portion configured to engage with the insulating layer. One of the accommodating portion and the wall-shaped portion includes a protrusion protruding toward the other of the accommodating portion and the wall-shaped portion. In the connector, the protrusion is configured to come into contact with the other to cause the wall-shaped portion to be displaced so as to approach the flat electric wire, whereby the contact portion comes into pressure contact with the conductor, and the engaging portion engages with the insulating layer.

A housing unit to be attached to an end portion of a flat electric wire, the housing unit includes: a housing; and a terminal configured to be accommodated in the housing. The terminal includes a wall-shaped portion defining a space in which a conductor of the flat electric wire is to be disposed and facing an inner surface of an accommodating portion of the housing, a contact portion provided on an inner surface of the wall-shaped portion and configured to come into pressure contact with the conductor, and an engaging portion configured to engage with an insulating layer of the flat electric wire. One of the accommodating portion and the wall-shaped portion includes a protrusion protruding toward the other of the accommodating portion and the wall-shaped portion. In the housing unit, the protrusion is configured to come into contact with the other to cause the wall-shaped portion to be displaced so as to approach the flat electric wire, whereby the contact portion comes into pressure contact with the conductor, and the engaging portion engages with the insulating layer.

According to the connector and the housing unit of the present disclosure, the terminal includes the wall-shaped portion facing the inner surface of the accommodating portion of the housing, the contact portion provided on the inner surface of the wall-shaped portion and configured to come into pressure contact with the conductor, and the engaging portion configured to engage with the insulating layer. Further, one of the accommodating portion and the wall-shaped portion has a protrusion protruding toward the other of the accommodating portion and the wall-shaped portion. Then, the protrusion is configured to come into contact with the other of the accommodating portion and the wall-shaped portion to cause the wall-shaped portion to be displaced so as to approach the flat electric wire, whereby the contact portion comes into pressure contact with the conductor, and the engaging portion engages with the insulating layer. Accordingly, as compared with a case in which the terminal is simply provided with the contact portion and the engaging portion, the contact between the contact portion and the conductor and the engagement between the engaging portion and the insulating layer are reinforced with the displacement of the wall-shaped portion of the terminal. Therefore, the connector and the housing unit according to the present disclosure are excellent in reliability of electrical connection between the flat electric wire and the terminal.

The present disclosure is briefly described above. Further, details of the present disclosure will be further clarified by reading modes for carrying out the disclosure described below with reference to the accompanying drawings.

### BRIEF DESCRIPTION OF DRAWINGS

FIG. 1 is a perspective view illustrating a connector according to a first embodiment of the present disclosure;

FIG. 2 is a perspective view illustrating an end portion of a flat electric wire illustrated in FIG. 1;

FIG. 3 is a cross-sectional view corresponding to a cross section A-A in FIG. 1 in a state in which a terminal accommodated in a housing is held in a temporary locking position;

FIG. 4 is a cross-sectional view corresponding to FIG. 3 in a state in which the end portion of the flat electric wire is inserted into a space between a pair of wall-shaped portions of the terminal from the state illustrated in FIG. 3;

FIG. 5 is a cross-sectional view corresponding to FIG. 3 in a state in which assembly of the connector is completed by the terminal being moved to a final locking position integrally with the flat electric wire from the state illustrated in FIG. 4 due to the pushing of the flat electric wire;

FIG. 6 is an enlarged view of a portion B in FIG. 5;

FIG. 7 is a cross-sectional view corresponding to FIG. 6 in a connector according to a second embodiment of the present disclosure;

FIG. 8 is a cross-sectional view corresponding to FIG. 6 in a connector according to a third embodiment of the present disclosure; and

FIG. 9 is a cross-sectional view corresponding to FIG. 6 in a connector according to a fourth embodiment of the present disclosure.

### DESCRIPTION OF EMBODIMENTS

### First Embodiment

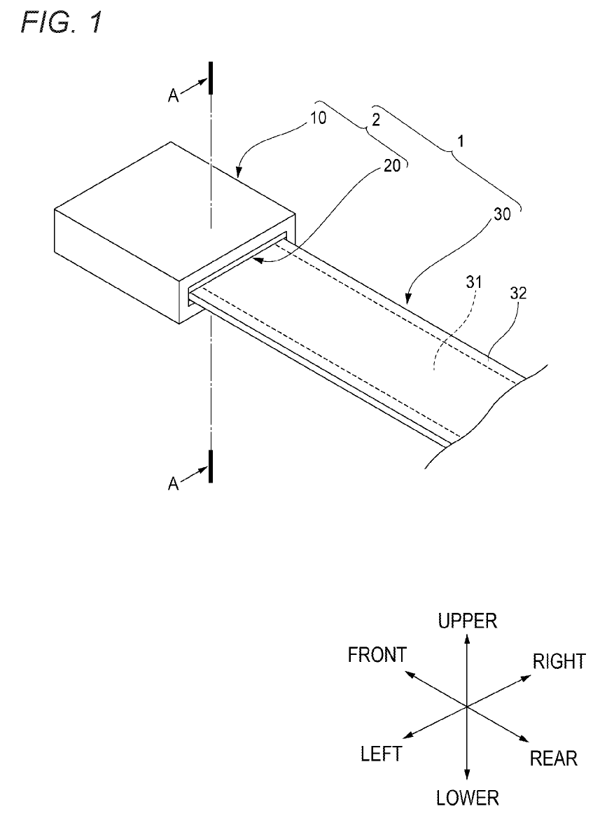

Hereinafter, a connector 1 according to a first embodiment of the present disclosure will be described with reference to FIGS. 1-6. As illustrated in FIG. 1 and the like, the connector 1 according to the first embodiment includes a housing 10, a terminal 20 accommodated in the housing 10, and a flat electric wire 30 electrically connected to the terminal 20. The housing 10 and the terminal 20 constituting the connector 1 constitute a housing unit 2 according to the present disclosure (see FIG. 1). The connector 1 is used by being mounted on a vehicle in a state of being fitted with a counterpart connector (not illustrated), for example.

Hereinafter, for convenience of description, "front", "rear", "left", "right", "upper", and "lower" are defined as illustrated in FIG. 1 or the like. A "front-rear direction", a "left-right direction", and an "upper-lower direction" are orthogonal to one another. The front-rear direction coincides with a fitting direction of the connector 1 and the counterpart connector, and also coincides with an extending direction of the flat electric wire 30. The front-rear direction, the left-right direction, and the upper-lower direction do not necessarily coincide with a front-rear direction, a left-right direction, and an upper-lower direction of a vehicle when the connector 1 is mounted on the vehicle. Hereinafter, a configuration of each member implementing the connector 1 will be described in order.

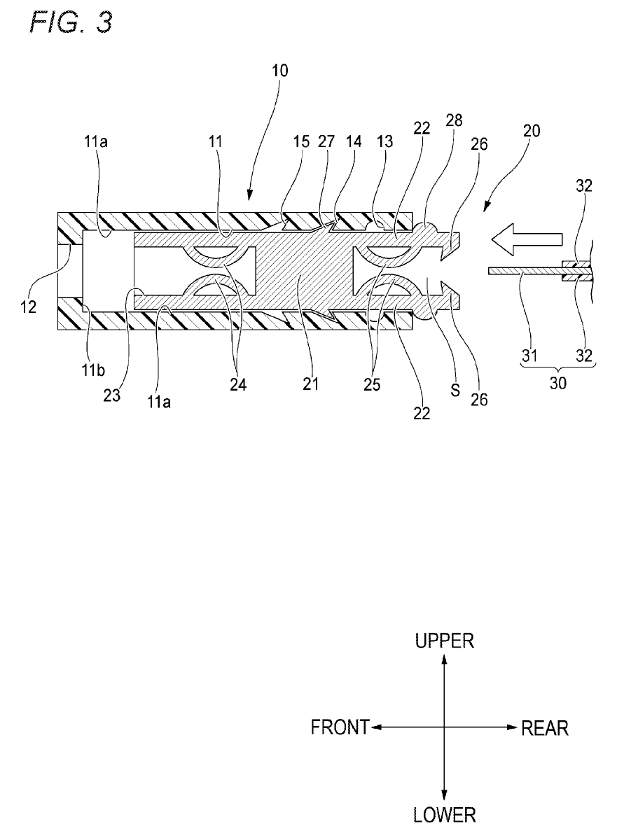

First, the housing 10 will be described. The housing 10 is a resin molded body, and as illustrated in FIGS. 1 and 3, has a substantially rectangular box shape that is flat and short in the upper-lower direction and extends in the front-rear direction. Inside the housing 10, a substantially rectangular parallelepiped hollow portion is defined, which is flat and short in the upper-lower direction, extends in the front-rear direction, and opens rearward. As illustrated in FIG. 3, the hollow portion functions as an accommodating portion 11 that accommodates the terminal 20.

As illustrated in FIG. 3, a front wall of the housing 10 is provided with a communicating hole 12 that communicates the outside of the housing 10 with the accommodating portion 11. When the connector 1 and the counterpart connector are fitted to each other, a counterpart terminal (not illustrated) belonging to the counterpart connector is inserted into the accommodating portion 11 of the housing 10 via the communicating hole 12 and electrically connected to the terminal 20 accommodated in the accommodating portion 11.

As illustrated in FIG. 3, in each of a pair of upper and lower inner surfaces 11a (inner surfaces of an upper wall and a lower wall of the housing 10) defining the accommodating portion 11 of the housing 10, a recess 13 positioned in the vicinity of a rear end in the front-rear direction, a temporary locking groove 14 positioned in front of the recess 13, and a final locking groove 15 positioned in front of the temporary locking groove 14 are provided so as to be arranged at intervals in the front-rear direction. Each of the recess 13, the temporary locking groove 14, and the final locking groove 15 has a groove shape that is recessed outward in the upper-lower direction and extends in the left-right direction. The operation of providing the recess 13, the temporary locking groove 14, and the final locking groove 15 will be described later.

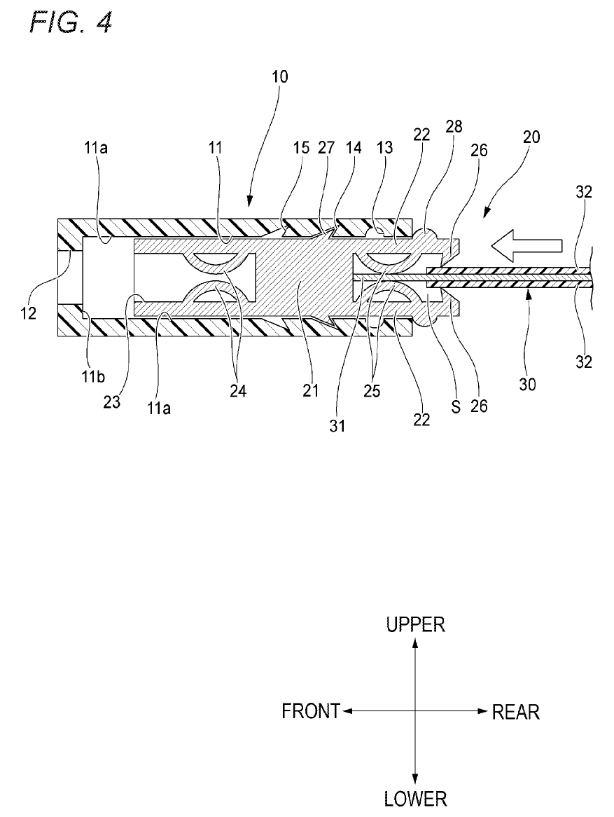

Next, the terminal 20 will be described. As illustrated in FIG. 3, the metal terminal 20 includes a main body portion 21 having a substantially rectangular parallelepiped shape that is flat and short in the upper-lower direction and extends in the front-rear direction, and a pair of upper and lower substantially rectangular flat plate-shaped wall-shaped portions 22 each extending rearward from upper and lower end edge portions of a rear end surface of the main body portion 21, and has an overall shape that can be accommodated in the accommodating portion 11 of the housing 10. The pair of upper and lower wall-shaped portions 22 are disposed to face each other at an interval in the upper-lower direction. Each of the pair of upper and lower wall-shaped portions 22 is elastically deformable so as to be displaced in the upper-lower direction. An end portion of the flat electric wire 30 is to be inserted and disposed in a space S defined by the pair of upper and lower wall-shaped portions 22 (see FIG. 4 and the like).

As illustrated in FIG. 3, a recess 23 recessed rearward is provided on a front end surface of the main body portion 21 of the terminal 20. When the connector 1 and the counterpart connector are fitted to each other, the counterpart terminal inserted into the accommodating portion 11 of the housing 10 through the communicating hole 12 is inserted into the recess 23. A contact portion 24 is provided on each of a pair of upper and lower inner surfaces defining the recess 23. In the example illustrated in FIG. 3, each of the pair of upper and lower contact portions 24 has a double-supported beam shape that protrudes toward the counterpart terminal inserted into the recess 23 (inward in the upper-lower direction) and extends in the front-rear direction. The counterpart terminal inserted into the recess 23 is electrically connected to the terminal 20 by being pressed and sandwiched by the pair of upper and lower contact portions 24.

As illustrated in FIG. 3, a contact portion 25 is provided on each of inner surfaces (surfaces facing each other) of the pair of upper and lower wall-shaped portions 22 of the terminal 20. In the example illustrated in FIG. 3, each of the pair of upper and lower contact portions 25 has a double-supported beam shape that protrudes toward the end portion of the flat electric wire 30 inserted into the space S between the pair of upper and lower wall-shaped portions 22 (inward in the upper-lower direction) and extends in the front-rear direction. Further, each of extending end portions (rear end portions) of the pair of upper and lower wall-shaped portions 22 of the terminal 20 is provided with an engaging protrusion 26 protruding toward the end portion of the flat electric wire 30 inserted into the space S between the pair of upper and lower wall-shaped portions 22 (inward in the upper-lower direction).

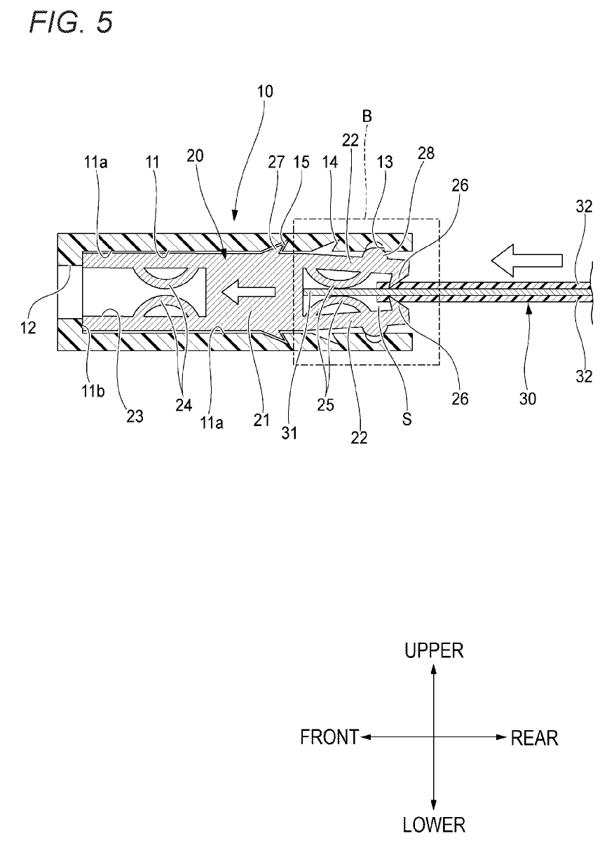

As illustrated in FIG. 3, each of the upper and lower surfaces of the main body portion 21 of the terminal 20 is provided with a locking protrusion 27 that corresponds to the temporary locking groove 14 and the final locking groove 15 of the housing 10. Further, each of outer surfaces (surfaces opposite to the surfaces facing each other) of the pair of upper and lower wall-shaped portions 22 of the terminal 20 is provided with a protrusion 28 that corresponds to the recess 13 of the housing 10. The locking protrusion 27 has a ridge shape that can be locked to the temporary locking groove 14 and the final locking groove 15, and the protrusion 28 has a ridge shape that can be engaged with the recess 13. The terminal 20 accommodated in the accommodating portion 11 of the housing 10 can be selectively held at any one of a position where the locking protrusion 27 is locked to the temporary locking groove 14 (see FIGS. 3 and 4; hereinafter, referred to as a "temporary locking position") and a position where the locking protrusion 27 is locked to the final locking groove 15 (see FIG. 5; hereinafter, referred to as a "final locking position").

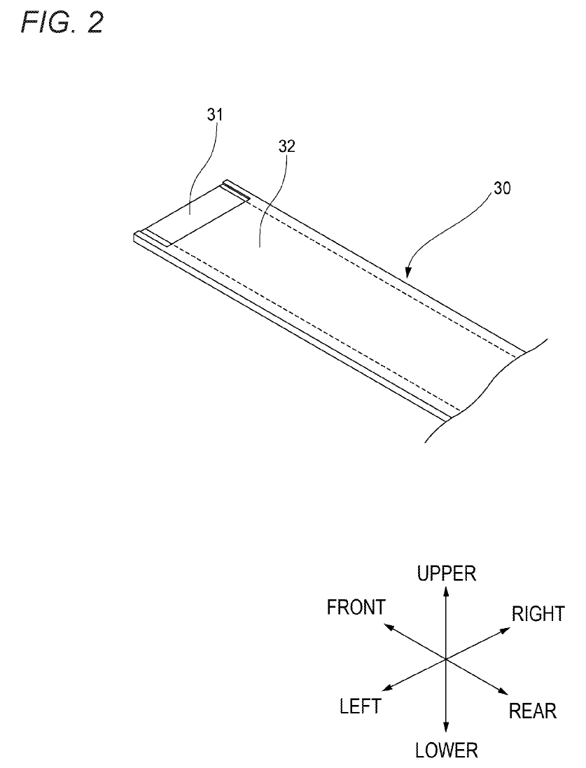

Next, the flat electric wire 30 will be described. As illustrated in FIGS. 2, 3, and the like, the flat electric wire 30 has a long flat shape that is flat and short in the upper-lower direction and extends in the front-rear direction, and has flexibility that allows the flat electric wire 30 to be routed so as to extend in the front-rear direction while being flexibly curved (bent) in the upper-lower direction. The flat electric wire 30 includes a sheet-like conductor layer 31 and an insulating layer 32 covering an outer periphery of the conductor layer 31. As illustrated in FIG. 2, at the end portion (front end portion) of the flat electric wire 30, the insulating layer 32 covering the upper side and the lower side of the conductor layer 31 is removed by so-called terminal processing, and the upper and lower surfaces of the conductor layer 31 are exposed. The configuration of each member that forms the connector 1 has been described above.

Next, an assembling procedure of the connector 1 will be described. In order to assemble the connector 1, first, as illustrated in FIG. 3, the terminal 20 is accommodated in the accommodating portion 11 of the housing 10 such that the terminal 20 is held at the temporary locking position. Specifically, the terminal 20 is inserted into the accommodating portion 11 of the housing 10 from the rear side until the locking protrusion 27 of the terminal 20 is fit (locked) into the temporary locking groove 14 of the housing 10. In the process of inserting the terminal 20, each of the upper and lower walls of the housing 10 is elastically deformed outward in the upper-lower direction by being pushed away (pressed) from the locking protrusion 27 until the locking protrusion 27 reaches the temporary locking groove 14, but is elastically restored inward in the upper-lower direction when the locking protrusion 27 reaches the temporary locking groove 14. As a result, the locking protrusion 27 is fitted and locked in the temporary locking groove 14.

In a state in which the terminal 20 accommodated in the accommodating portion 11 is held at the temporary locking position in the housing 10, as illustrated in FIG. 3, the outer surface of the wall-shaped portion 22 of the terminal 20 is arranged to face the inner surface 11a of the accommodating portion 11 of the housing 10. However, the protrusion 28 provided on the outer surface of the wall-shaped portion 22 of the terminal 20 is positioned outside the accommodating portion 11 (behind the rear end opening of the accommodating portion 11) and is not in contact with the inner surface 11a of the accommodating portion 11. Therefore, the pair of upper and lower wall-shaped portions 22 of the terminal 20 are maintained in a non-elastically deformed state.

Next, as indicated by the white arrow in FIG. 3, the end portion of the flat electric wire 30 is inserted into the space S between the pair of upper and lower wall-shaped portions 22 of the terminal 20 from a rear side. In an inserted state of the flat electric wire 30, as illustrated in FIG. 4, a tip of the exposed conductor layer 31 of the flat electric wire 30 is in contact with the rear end surface of the main body portion 21 of the terminal 20. In the example illustrated in FIG. 4, the exposed conductor layer 31 of the flat electric wire 30 is sandwiched between (in contact with) the pair of upper and lower contact portions 25 of the terminal 20, and the end portion of the insulating layer 32 of the flat electric wire 30 is sandwiched between (in contact with) the pair of upper and lower engaging protrusions 26 of the terminal 20. Accordingly, the flat electric wire 30 can be positioned with respect to the terminal 20. However, at this stage, the exposed conductor layer 31 of the flat electric wire 30 may not be sandwiched between (in contact with) the pair of upper and lower contact portions 25 of the terminal 20, and the end portion of the insulating layer 32 of the flat electric wire 30 may not be sandwiched between (in contact with) the pair of upper and lower engaging protrusions 26 of the terminal 20.

Next, the terminal 20 held at the temporary locking position is moved to the final locking position and held at the final locking position. Therefore, as indicated by the white arrow in FIG. 4, the flat electric wire 30 is pushed forward. When the flat electric wire 30 is pushed in this way, the tip of the flat electric wire 30 (the tip of the conductor layer 31) pushes the main body portion 21 of the terminal 20, whereby the terminal 20 moves forward toward the final locking position integrally with the flat electric wire 30 as indicated by the white arrow in FIG. 5. The pushing of the flat electric wire 30 is continued until the locking protrusion 27 of the terminal 20 is fitted (locked) into the final locking groove 15 of the housing 10. In the process of moving the terminal 20 to the final locking position, each of the upper and lower walls of the housing 10 is elastically deformed outward in the upper-lower direction by being pushed away (pressed) from the locking protrusion 27 until the locking protrusion 27 reaches the final locking groove 15, but is elastically restored inward in the upper-lower direction when the locking protrusion 27 reaches the final locking groove 15. As a result, the locking protrusion 27 is fitted and locked in the final locking groove 15.

Here, instead of pushing the flat electric wire 30 as described above, the terminal 20 (more specifically, the extending end portion of the wall-shaped portion 22 of the terminal 20 protruding rearward from the accommodating portion 11) may be directly pushed forward to move the terminal 20 forward toward the final locking position integrally with the flat electric wire 30. The pushing of the flat electric wire 30 or the terminal 20 described above may be performed manually by an operator, or may be performed using an arm or the like of an automatic assembly apparatus (not illustrated). In a state in which the terminal 20 is held at the final locking position, as illustrated in FIG. 5, a front end surface of the terminal 20 (the front end surface of the main body portion 21) is in contact with a bottom wall 11b defining a front end surface of the accommodating portion 11 of the housing 10. Accordingly, further forward relative movement of the terminal 20 with respect to the housing 10 is prevented.

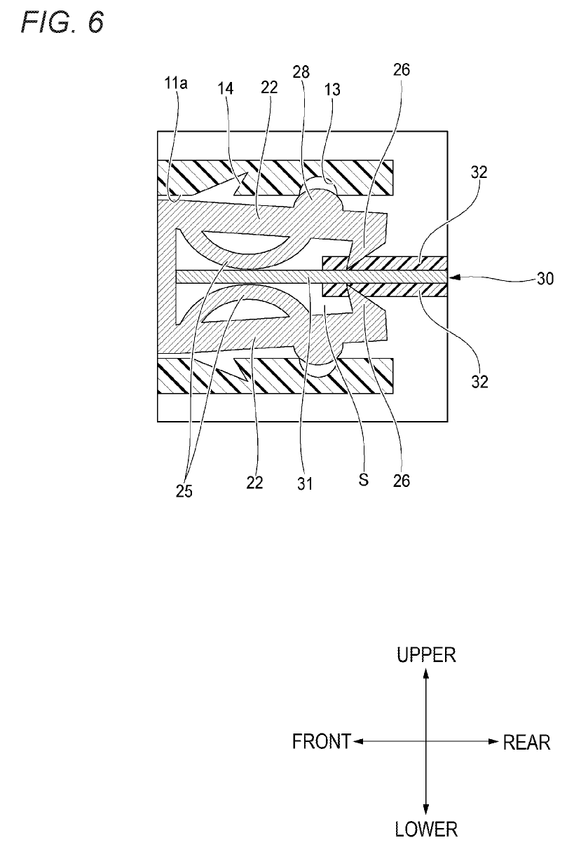

In a state in which the terminal 20 accommodated in the accommodating portion 11 is held at the final locking position in the housing 10, as illustrated in FIGS. 5 and 6, the protrusion 28 provided on the outer surface of the wall-shaped portion 22 of the terminal 20 is fitted and engaged with the recess 13 provided on the inner surface 11a of the accommodating portion 11. However, since the convex shape of the protrusion 28 is larger than the concave shape of the recess 13, only a part of the protrusion 28 on a distal end side enters the recess 13, and a part of the protrusion 28 on a proximal end side is positioned outside the recess 13 (inward in the upper-lower direction relative to the inner surface 11a). In this way, the part of the protrusion 28 on the proximal end side is positioned outside the recess 13 (inward in the upper-lower direction relative to the inner surface 11a), so that the pair of upper and lower wall-shaped portions 22 of the terminal 20 are maintained in a state of being displaced inward in the upper-lower direction (toward the flat electric wire 30) by elastic deformation due to being pushed away (pressed) from the recess 13 (inner surface 11a) of the housing 10.

Since the pair of upper and lower wall-shaped portions 22 are maintained in the displaced state in this way, as illustrated in FIG. 6, the exposed conductor layer 31 of the flat electric wire 30 is pressed and sandwiched by (in pressure contact with) the pair of upper and lower contact portions 25 of the terminal 20, and the pair of upper and lower engaging protrusions 26 of the terminal 20 are engaged with the end portion of the insulating layer 32 of the flat electric wire 30 so as to bite thereinto while being in pressure contact therewith. As described above, since the protrusion 28 functions to displace the wall-shaped portion 22, the contact between the contact portion 25 of the terminal 20 and the conductor layer 31 of the flat electric wire 30 and the engagement between the engaging protrusion 26 of the terminal 20 and the insulating layer 32 of the flat electric wire 30 are reinforced as the wall-shaped portion 22 of the terminal 20 is displaced.

As described above, the assembly of the connector 1 is completed, and the connector 1 illustrated in FIGS. 1, 5 and 6 is obtained. In the assembled state of the connector 1, the exposed conductor layer 31 of the flat electric wire 30 is pressed and sandwiched by the pair of upper and lower contact portions 25 of the terminal 20, so that the flat electric wire 30 is electrically connected to the terminal 20. Further, in the example illustrated in FIG. 6, the sharp tip portion of the engaging protrusion 26 of the terminal 20 pierces the end portion of the insulating layer 32 of the flat electric wire 30, and is in contact with the conductor layer 31 covered with the end portion of the insulating layer 32. Such contact between the engaging protrusion 26 of the terminal 20 and the conductor layer 31 of the flat electric wire 30 can further enhance the reliability of the electrical connection between the flat electric wire 30 and the terminal 20.

As described above, according to the connector 1 of the first embodiment, the terminal 20 includes the wall-shaped portion 22 defining the space S in which the conductor (conductor layer 31) of the flat electric wire 30 is to be disposed and facing the inner surface 11a of the accommodating portion 11 of the housing 10, the contact portion 25 provided on the inner surface of the wall-shaped portion 22 and configured to come into pressure contact with the conductor layer 31, and the engaging portion (engaging protrusion 26) configured to engage with the insulating layer 32. Further, one (wall-shaped portion 22) of the accommodating portion 11 and the wall-shaped portion 22 includes the protrusion 28 protruding toward the other (accommodating portion 11) of the accommodating portion 11 and the wall-shaped portion 22. In the connector 1, the protrusion 28 is configured to come into contact with the other (accommodating portion 11) to cause the wall-shaped portion 22 to be displaced so as to approach the flat electric wire 30, whereby the contact portion 25 comes into pressure contact with the conductor layer 31, and the engaging protrusion 26 engages with the insulating layer 32. Accordingly, as compared with a case in which the terminal 20 is simply provided with the contact portion 25 and the engaging protrusion 26, the contact between the contact portion 25 and the conductor layer 31 and the engagement between the engaging protrusion 26 and the insulating layer 32 are reinforced with the displacement of the wall-shaped portion 22 of the terminal 20. Therefore, the connector 1 according to the first embodiment is excellent in reliability of electrical connection between the terminal 20 and the flat electric wire 30.

Further, according to the connector 1 of the first embodiment, the protrusion 28 is configured to engage with the recess 13 of the other (accommodating portion 11) of the accommodating portion 11 and the wall-shaped portion 22. Therefore, in addition to the function of causing the wall-shaped portion 22 to be displaced as described above, the protrusion 28 also has a function of engaging with the other (accommodating portion 11) of the accommodating portion 11 and the wall-shaped portion 22 to hold the terminal 20 in the housing 10. Accordingly, the terminal 20 can be firmly held in the housing 10 without increasing the size of the connector 1.

Further, according to the connector 1 of the first embodiment, the contact portion 25 of the terminal 20 has a beam shape protruding toward the conductor layer 31 of the flat electric wire 30. Therefore, even when an external force such as vibration is applied to the connector 1 during use of the connector 1, the contact portion 25 is elastically deformed to absorb the external force so as to appropriately maintain a state in which the contact portion 25 and the conductor 31 are in pressure contact with each other. Accordingly, the reliability of the electrical connection between the terminal 20 and the flat electric wire 30 can be further improved.

Further, according to the connector 1 of the first embodiment, the terminal 20 can be held in the housing 10 at a first position (for example, the temporary locking position) where the locking portion (the locking protrusion 27) of the terminal 20 is locked to a first locked portion (the temporary locking groove 14) of the housing 10 and at a second position (for example, the final locking position) where the locking portion (the locking protrusion 27) of the terminal 20 is locked to a second locked portion (the final locking groove 15) of the housing 10. Therefore, for example, after the flat electric wire 30 is disposed in the space S defined by the wall-shaped portion 22 of the terminal 20 at the first position, the terminal 20 and the flat electric wire 30 are integrally moved to the second position, whereby the contact portion 25 can be brought into pressure contact with the conductor layer 31, and the engaging protrusion 26 can be engaged with the insulating layer 32. Accordingly, the accommodation of the terminal 20 in the housing 10 and the connection of the terminal 20 and the flat electric wire 30 can be collectively performed, and thus the productivity of the connector 1 can be improved.

### Second Embodiment

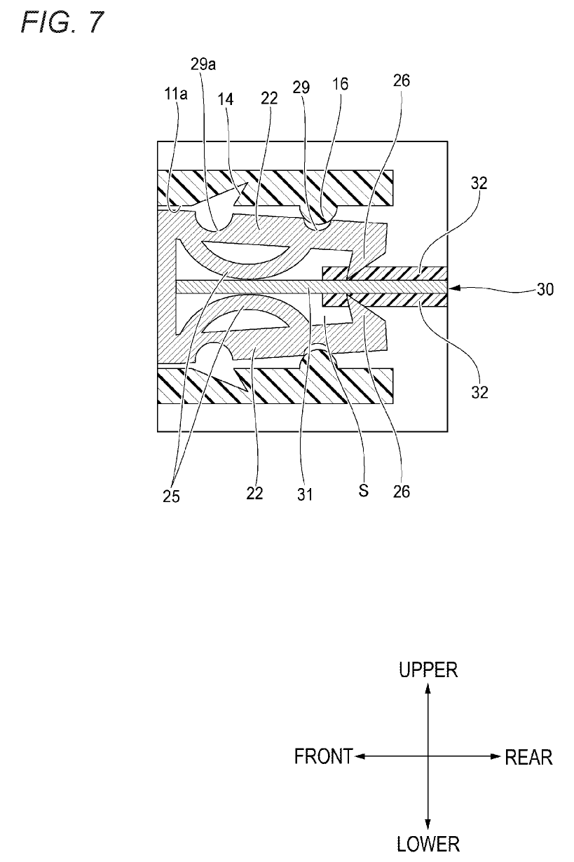

Hereinafter, the connector 1 according to a second embodiment of the present disclosure will be described with reference to FIG. 7. The second embodiment is different from the first embodiment in which the protrusion 28 provided on the outer surface of the wall-shaped portion 22 of the terminal 20 and the recess 13 provided on the inner surface 11a of the accommodating portion 11 of the housing 10 are engaged with each other in that a protrusion 16 (instead of the recess 13) provided on the inner surface 11a of the accommodating portion 11 of the housing 10 and a recess 29 (instead of the protrusion 28) provided on the outer surface of the wall-shaped portion 22 of the terminal 20 are engaged with each other at a final locking position of the terminal 20. In the second embodiment, a recess 29a to be engaged with the protrusion 16 of the housing 10 at a temporary locking position of the terminal 20 is further provided at a position in front of the recess 29 on the outer surface of the wall-shaped portion 22 of the terminal 20.

In the second embodiment, since the convex shape of the protrusion 16 is smaller than the concave shape of the recess 29a, the entire protrusion 16 can enter the recess 29a at the temporary locking position of the terminal 20. Therefore, at the temporary locking position of the terminal 20, the pair of upper and lower wall-shaped portions 22 of the terminal 20 are maintained in a non-elastically deformed state. Meanwhile, since the convex shape of the protrusion 16 is larger than the concave shape of the recess 29, at the final locking position of the terminal 20, only a part of the protrusion 16 on a distal end side enters the recess 29, and a part of the protrusion 16 on a proximal end side is positioned outside the recess 29 (outward in an upper-lower direction relative to the outer surface of the wall-shaped portion 22). In this way, the part of the protrusion 16 on the proximal end side is positioned outside the recess 29 (outward in the upper-lower direction relative to the outer surface of the wall-shaped portion 22), so that the pair of upper and lower wall-shaped portions 22 of the terminal 20 are maintained in a state of being displaced inward in the upper-lower direction (toward the flat electric wire 30) by elastic deformation due to being pushed away (pressed) from the protrusion 16 of the housing 10. As described above, since the protrusion 16 functions to displace the wall-shaped portion 22, in the second embodiment as well, as in the first embodiment, the contact between the contact portion 25 of the terminal 20 and the conductor layer 31 of the flat electric wire 30 and the engagement between the engaging protrusion 26 of the terminal 20 and the insulating layer 32 of the flat electric wire 30 are reinforced as the wall-shaped portion 22 of the terminal 20 is displaced.

### Third Embodiment

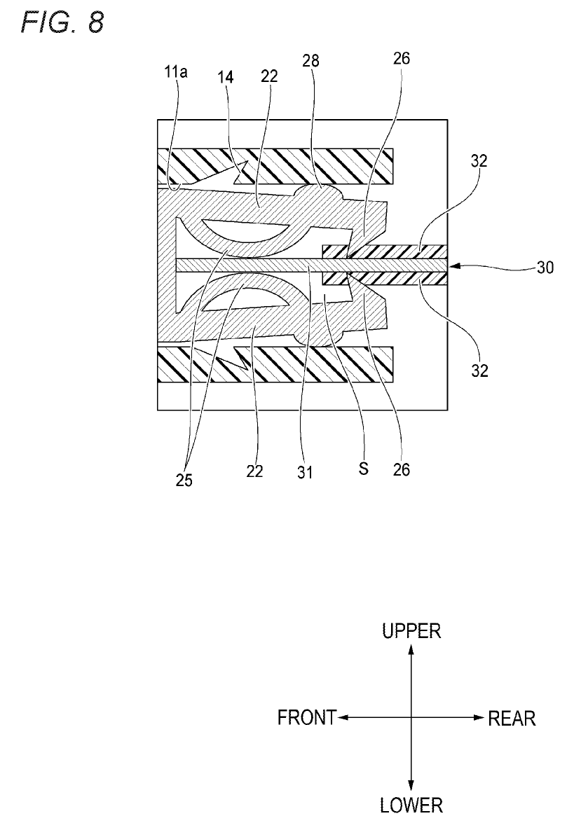

Hereinafter, the connector 1 according to a third embodiment of the present disclosure will be described with reference to FIG. 8. The third embodiment is different from the first embodiment in which the recess 13 is provided on the inner surface 11a of the accommodating portion 11 of the housing 10 in that the recess 13 is not provided on the inner surface 11a of the accommodating portion 11 of the housing 10.

In the third embodiment, as in the first embodiment, at a temporary locking position of the terminal 20, the protrusion 28 provided on an outer surface of the wall-shaped portion 22 of the terminal 20 is positioned outside the accommodating portion 11 (behind a rear end opening of the accommodating portion 11) and is not in contact with the inner surface 11a of the accommodating portion 11. Therefore, the wall-shaped portion 22 of the terminal 20 is maintained in a non-elastically deformed state. Meanwhile, at a final locking position of the terminal 20, a distal end of the protrusion 28 is in contact with the inner surface 11a of the accommodating portion 11, and the entire protrusion 28 is positioned inward in an upper-lower direction relative to the inner surface 11a of the accommodating portion 11. In this way, the entire protrusion 28 is positioned inward in the upper-lower direction relative to the inner surface 11a of the accommodating portion 11, so that the pair of upper and lower wall-shaped portions 22 of the terminal 20 are maintained in a state of being displaced inward in the upper-lower direction (toward the flat electric wire 30) by elastic deformation due to being pushed away (pressed) from the inner surface 11a of the accommodating portion 11. As described above, in the third embodiment as well, since the protrusion 28 functions to displace the wall-shaped portion 22, as in the first embodiment, the contact between the contact portion 25 of the terminal 20 and the conductor layer 31 of the flat electric wire 30 and the engagement between the engaging protrusion 26 of the terminal 20 and the insulating layer 32 of the flat electric wire 30 are reinforced as the wall-shaped portion 22 of the terminal 20 is displaced. In the present embodiment, the protrusion 28 is provided outside the accommodating portion 11, but instead of providing the protrusion 28 outside the accommodating portion 11, the protrusion 16 may be provided on the inner surface 11a of the accommodating portion 11 of the housing 10 and the protrusion 28 may not be provided outside the accommodating portion 11 as in the second embodiment.

### Fourth Embodiment

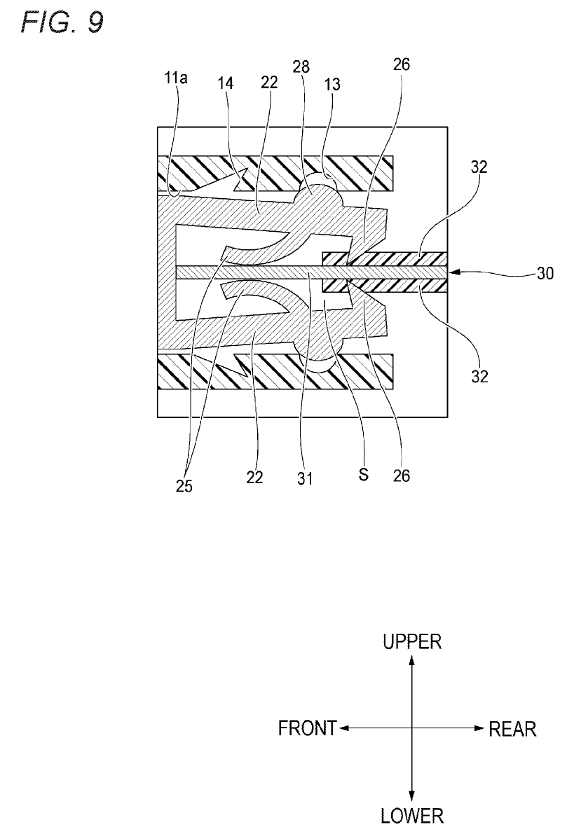

Hereinafter, the connector 1 according to a fourth embodiment of the present disclosure will be described with reference to FIG. 9. The fourth embodiment is different from the first embodiment in which the contact portion 25 of the terminal 20 has a double-supported beam shape extending in the front-rear direction in that the contact portion 25 of the terminal 20 has a cantilever shape extending in the front-rear direction.

In the fourth embodiment, by the same mechanism as in the first embodiment, the pair of upper and lower wall-shaped portions 22 of the terminal 20 are maintained in a non-elastically deformed state at a temporary locking position of the terminal 20, and the pair of upper and lower wall-shaped portions 22 of the terminal 20 are maintained in a state of being displaced inward in the upper-lower direction (toward the flat electric wire 30) by elastic deformation due to being pushed away (pressed) from the inner surface 11a of the accommodating portion 11 at the final locking position of the terminal 20. As described above, in the fourth embodiment as well, since the protrusion 28 functions to displace the wall-shaped portion 22, as in the first embodiment, the contact between the contact portion 25 of the terminal 20 and the conductor layer 31 of the flat electric wire 30 and the engagement between the engaging protrusion 26 of the terminal 20 and the insulating layer 32 of the flat electric wire 30 are reinforced as the wall-shaped portion 22 of the terminal 20 is displaced.

### Other Embodiments

The present disclosure is not limited to the embodiments described above, and various modifications can be adopted within the scope of the present disclosure. For example, the present disclosure is not limited to the embodiments described above, and modifications, improvements, and the like can be appropriately made. In addition, materials, shapes, dimensions, numbers, arrangement positions, and the like of the respective constituent elements in the above embodiments are optionally selected and are not limited as long as the present disclosure can be implemented.

For example, in the above embodiments, the flat electric wire 30 includes one conductor layer 31. With respect to this, the flat electric wire 30 may include a plurality of conductor layers 31 arranged in a width direction or a thickness direction.

Further, in the above embodiments, the contact portions 25 are in contact with the upper and lower surfaces of the conductor layer 31 exposed at the end portion of the flat electric wire 30. With respect to this, a reinforcing layer (for example, a layer in which the insulating layer 32 above or below the conductor layer 31 is left without being removed, a plate material attached to the upper surface or the lower surface of the flat electric wire 30, a dummy conductor layer that is not used as a circuit when the flat electric wire 30 has a multilayer structure, or the like) may be provided above or below the conductor layer 31. Accordingly, for example, the step of inserting the end portion of the flat electric wire 30 into the terminal 20 (see FIGS. 3 and 4) can be easily performed.

Here, the features of the embodiments of the connector 1 and the housing unit 2 according to the present disclosure described above will be briefly summarized and listed in the following a first aspect to a fifth aspect.

### First aspect

A connector (1) including:
a housing (10);
a terminal (20) configured to be accommodated in the housing (10); and
a flat electric wire (30) configured to be electrically connected to the terminal (20), in which
the flat electric wire (30) includes a conductor (31) and an insulating layer (32) sandwiching the conductor (31),
the terminal (20) includes a wall-shaped portion (22) defining a space (S) in which the conductor (31) of the flat electric wire (30) is to be disposed and facing an inner surface (11a) of an accommodating portion (11) of the housing (10), a contact portion (25) provided on an inner surface of the wall-shaped portion (22) and configured to come into pressure contact with the conductor (31), and an engaging portion (26) configured to engage with the insulating layer (32),
one of the accommodating portion (11) and the wall-shaped portion (22) includes a protrusion (28) protruding toward the other of the accommodating portion (11) and the wall-shaped portion (22), and
in the connector (1), the protrusion (28) is configured to come into contact with the other to cause the wall-shaped portion (22) to be displaced so as to approach the flat electric wire (30), whereby the contact portion (25) comes into pressure contact with the conductor (31), and the engaging portion (26) engages with the insulating layer (32).

According to the connector described in the above the first aspect, the terminal includes the wall-shaped portion facing the inner surface of the accommodating portion of the housing, the contact portion provided on the inner surface of the wall-shaped portion and configured to come into pressure contact with the conductor, and the engaging portion configured to engage with the insulating layer. Further, one of the accommodating portion and the wall-shaped portion has a protrusion protruding toward the other of the accommodating portion and the wall-shaped portion. Then, the protrusion is configured to come into contact with the other of the accommodating portion and the wall-shaped portion to cause the wall-shaped portion to be displaced so as to approach the flat electric wire, whereby the contact portion comes into pressure contact with the conductor, and the engaging portion engages with the insulating layer. Accordingly, as compared with a case in which the terminal is simply provided with the contact portion and the engaging portion, the contact between the contact portion and the conductor and the engagement between the engaging portion and the insulating layer are reinforced with the displacement of the wall-shaped portion of the terminal. Therefore, the connector and the housing unit according to the present disclosure are excellent in reliability of electrical connection between the flat electric wire and the terminal.

### Second aspect

The connector (1) according to the first aspect, in which
the protrusion (28) is configured to engage with a recess (13) of the other of the accommodating portion (11) and the wall-shaped portion (22).

According to the connector described in the above the second aspect, the protrusion engages with the recess of the other of the accommodating portion and the wall-shaped portion. Therefore, in addition to the function of causing the wall-shaped portion to be displaced as described above, the protrusion also has a function of engaging with the other of the accommodating portion and the wall-shaped portion to hold the terminal in the housing. Accordingly, the terminal can be firmly held in the housing without increasing the size of the connector.

### Third aspect

The connector (1) according to the above the first aspect, in which
the contact portion (25) of the terminal (20) has a beam shape protruding toward the conductor (31) of the flat electric wire (30).

According to the connector described in the above the third aspect, the contact portion of the terminal has a beam shape protruding toward the conductor of the flat electric wire. Therefore, even when an external force such as vibration is applied to the connector during use of the connector, the contact portion is elastically deformed to absorb the external force so as to appropriately maintain a state in which the contact portion and the conductor are in pressure contact with each other. Accordingly, the reliability of the electrical connection between the flat electric wire and the terminal can be further improved.

### Fourth aspect

The connector (1) according to the first aspect, in which
the terminal (20) includes a locking portion (27) configured to engage with the accommodating portion (11) to hold the terminal (20) in the accommodating portion (11), and
the housing (10) includes a first locked portion (14) to which the locking portion (27) is to be locked at a first position where the protrusion (28) is not in contact with the other of the accommodating portion (11) and the wall-shaped portion (22), and a second locked portion (15) to which the locking portion (27) is to be locked at a second position where the protrusion (28) is in contact with the other.

According to the connector described in the above the fourth aspect, the terminal can be held in the housing at a first position (for example, the temporary locking position) where the locking portion of the terminal is locked to a first locked portion of the housing and at a second position (for example, the final locking position) where the locking portion of the terminal is locked to a second locked portion of the housing. Therefore, for example, after the flat electric wire is disposed in the space defined by the wall-shaped portion of the terminal at the first position, the terminal and the flat electric wire are integrally moved to the second position, whereby the contact portion can be brought into pressure contact with the conductor, and the engaging portion can be engaged with the insulating layer. Accordingly, the accommodation of the terminal in the housing and the connection of the terminal and the flat electric wire can be collectively performed, and thus the productivity of the connector can be improved.

### Fifth aspect

A housing unit (2) to be attached to an end portion of a flat electric wire (30), the housing unit including:
a housing (10); and a terminal (20) configured to be accommodated in the housing (10), in which
the terminal (20) includes a wall-shaped portion (22) defining a space (S) in which a conductor (31) of the flat electric wire (30) is to be disposed and facing an inner surface (11a) of an accommodating portion (11) of the housing (10), a contact portion (25) provided on an inner surface of the wall-shaped portion (22) and configured to come into pressure contact with the conductor (31), and an engaging portion (26) configured to engage with an insulating layer (32) of the flat electric wire (30),
one of the accommodating portion (11) and the wall-shaped portion (22) includes a protrusion (28) protruding toward the other of the accommodating portion (11) and the wall-shaped portion (22), and
in the housing unit (2), the protrusion (28) is configured to come into contact with the other to cause the wall-shaped portion (22) to be displaced so as to approach the flat electric wire (30), whereby the contact portion (25) comes into pressure contact with the conductor (31), and the engaging portion (26) engages with the insulating layer (32).

According to the housing unit described in the above the fifth aspect, the terminal includes the wall-shaped portion defining the space in which the conductor of the flat electric wire is to be disposed and facing the inner surface of the accommodating portion of the housing, the contact portion provided on the inner surface of the wall-shaped portion and configured to come into pressure contact with the conductor, and the engaging portion configured to engage with the insulating layer. Further, one of the accommodating portion and the wall-shaped portion has a protrusion protruding toward the other of the accommodating portion and the wall-shaped portion. In the connector, the protrusion is configured to come into contact with the other to cause the wall-shaped portion to be displaced so as to approach the flat electric wire, whereby the contact portion comes into pressure contact with the conductor, and the engaging portion engages with the insulating layer. Accordingly, as compared with a case in which the terminal is simply provided with the contact portion and the engaging portion, the contact between the contact portion and the conductor and the engagement between the engaging portion and the insulating layer are reinforced with the displacement of the wall-shaped portion of the terminal. Therefore, the housing unit having this configuration is excellent in reliability of electrical connection between the flat electric wire and the terminal.

What is claimed is:

1. A connector comprising:
a housing;
a terminal configured to be accommodated in the housing; and
a flat electric wire configured to be electrically connected to the terminal,
wherein the flat electric wire includes a conductor and an insulating layer sandwiching the conductor,
wherein the terminal includes a wall-shaped portion defining a space in which the conductor of the flat electric wire is to be disposed and facing an inner surface of an accommodating portion of the housing, a contact portion provided on an inner surface of the wall-shaped portion and configured to come into pressure contact with the conductor, and an engaging portion configured to engage with the insulating layer,
wherein one of the accommodating portion and the wall-shaped portion includes a protrusion protruding toward the other of the accommodating portion and the wall-shaped portion, and
wherein, in the connector, the protrusion is configured to come into contact with the other to cause the wall-shaped portion to be displaced so as to approach the flat electric wire, whereby the contact portion comes into pressure contact with the conductor, and the engaging portion engages with the insulating layer.

2. The connector according to claim 1,
wherein the protrusion is configured to engage with a recess of the other of the accommodating portion and the wall-shaped portion.

3. The connector according to claim 1,
wherein the contact portion of the terminal has a beam shape protruding toward the conductor of the flat electric wire.

4. The connector according to claim 1,
wherein the terminal includes a locking portion configured to engage with the accommodating portion to hold the terminal in the accommodating portion, and
wherein the housing includes a first locked portion to which the locking portion is to be locked at a first position where the protrusion is not in contact with the other of the accommodating portion and the wall-shaped portion, and a second locked portion to which the locking portion is to be locked at a second position where the protrusion is in contact with the other.

5. A housing unit to be attached to an end portion of a flat electric wire, the housing unit comprising:
a housing; and
a terminal configured to be accommodated in the housing,
wherein the terminal includes a wall-shaped portion defining a space in which a conductor of the flat electric wire is to be disposed and facing an inner surface of an accommodating portion of the housing, a contact portion provided on an inner surface of the wall-shaped portion and configured to come into pressure contact with the conductor, and an engaging portion configured to engage with an insulating layer of the flat electric wire,
wherein one of the accommodating portion and the wall-shaped portion includes a protrusion protruding toward the other of the accommodating portion and the wall-shaped portion, and
wherein, in the housing unit, the protrusion is configured to come into contact with the other to cause the wall-shaped portion to be displaced so as to approach the flat electric wire, whereby the contact portion comes into pressure contact with the conductor, and the engaging portion engages with the insulating layer.
